(19) United States
(12) Patent Application Publication
(10) Pub. No.: US 2016/0252007 A1
(43) Pub. Date: Sep. 1, 2016

(54) PRE-CHAMBER ASSEMBLY FOR ENGINE

(71) Applicant: Caterpillar Inc., Peoria, IL (US)

(72) Inventors: Xinyu Ge, Peoria, IL (US); Xinqiang Xu, Peoria, IL (US); Liang Wang, Peoria, IL (US)

(73) Assignee: Caterpillar Inc., Peoria, IL (US)

(21) Appl. No.: 15/149,455

(22) Filed: May 9, 2016

(51) Int. Cl. F02B 19/16

(52) U.S. Cl. CPC F02B 19/16; F02B 2019/006

(57) ABSTRACT

A pre-chamber assembly for an engine having a cylinder head defining a coolant passage is provided. The pre-chamber assembly includes a body member defining pre-combustion chamber received within the cylinder head, and a plurality of fins projecting radially from an outer surface of the body member. The plurality of fins includes a first set of fins proximate to the pre-combustion chamber, a second set of fins spaced apart from the first set of fins along a longitudinal axis, and a third set of fins disposed between the first set of fins and the second set of fins. A number of fins of the first set of fins is greater than a number of fins of the third set of fins, and the number of fins of the third set of fins is greater than a number of fins of the second set of fins.

### TECHNICAL FIELD

The present disclosure relates to internal combustion engines, and more particularly to a pre-chamber assembly for an internal combustion engine.

### BACKGROUND

With the development of engine technology, an internal combustion engine, hereinafter referred to as the engine, includes a pre-chamber disposed within a cylinder head of the engine. The pre-chamber assists in initiation of ignition of gaseous fuels in a combustion chamber. Generally, the pre-chamber is in communication with the combustion chamber, via a number of orifices. The pre-chamber receives gaseous fuel from a solenoid controlled fuel admission valve associated with the pre-chamber. A spark plug associated with the pre-chamber ignites a mixture of the gaseous fuel and air present in the pre-chamber. Ignition of the mixture of the gaseous fuel and air creates a flame front of burning fuel in the pre-chamber which is introduced into the combustion chamber through the orifices. The pre-chamber is subjected to high temperatures due to the ignition of the mixture of the gaseous fuel and air. This may cause damage to the solenoid controlled fuel admission valve, thereby causing degradation in performance of the engine. Thus, in order to dissipate heat from the pre-chamber, cooling of the pre-chamber is desired.

A coolant pump circulates coolant through coolant passages defined within the engine head such that the pre-chamber is cooled through forced convective heat transfer. However, during a hot shutdown condition in which an engine is turned off from a high load condition, the coolant pump is stopped and therefore, the coolant is not circulated through the coolant passages. Hence, forced convective heat transfer is replaced by conductive heat transfer, thereby leading, to extra heat that may not dissipate from the pre-chamber into the coolant. This may cause overheating of the solenoid controlled fuel admission valve and may cause boiling of the coolant surrounding the pre-chamber.

U.S. Pat. No. 5,662,082, hereinafter referred to as '082 patent, describes a pre-combustion chamber that is adapted to be installed in a spark plug well of an existing engine. The pre-combustion Chamber includes an inner combustion chamber housing and an outer cooling jacket housing. The inner combustion chamber and the outer cooling jacket housing are assembled in such a manner to permit movement therebetween during thermal cycling to minimize stress and fatigue fracture. The pre-combustion chamber of the '082 patent utilizes a resilient seal that is installed between the inner combustion chamber and the outer cooling jacket housing. However, the pre-combustion chamber of the '082 patent may not be effectively cooled during various operating conditions of the engine, especially during a hat shutdown condition.

### SUMMARY OF THE DISCLOSURE

In one aspect of the present disclosure, a pre-chamber assembly for an engine having a cylinder head is provided. The cylinder head defines a coolant passage therein. The pre-chamber assembly includes a body member received within the cylinder head. The body member has an inner surface and an outer surface facing the coolant passage of the cylinder head. The body member defines a pre-combustion chamber at an end portion thereof. The pre-combustion chamber is in communication with a main combustion chamber of the engine through at least one orifice. The pre-chamber assembly also includes a plurality of fins projecting radially from the outer surface of the body member. The fins are in contact with coolant received within the coolant passage of the cylinder head. Each fin of the plurality of fins extends along a longitudinal axis of the body member. The fins are positioned along the longitudinal axis of the body member in a predetermined pattern. The fins include a first set of fins provided on the outer surface of the body member and proximate to the pre-combustion chamber defined at the end portion of the body member. The fins include a second set of fins provided on the outer surface of the body member and spaced apart from the first set of fins along the longitudinal axis. The fins include a third set of fins provided on the outer surface of the body member and disposed between the first set of fins and the second set of fins. Further, a number of fins of the first set of fins is greater than a number of fins of the third set of fins, and the number of fins of the third set of fins is greater than a number of fins of the second set of fins.

Other features and aspects of this disclosure will be apparent from the following description and the accompanying drawings.

### BRIEF DESCRIPTION OF THE DRAWINGS

FIG. 1 is a perspective view of an exemplary engine, according to one embodiment of the present disclosure

FIG. 2 illustrates a sectional view of a portion of the engine having a pre-chamber assembly, according to one embodiment of the present disclosure;

FIG. 3 illustrates a side view of the pre-chamber assembly of FIG. 2;

FIG. 4 illustrates an enlarged view of a region A-A′ of FIG. 3, showing a plurality of fins; and

FIG. 5 is a schematic diagram of the pre-chamber assembly illustrating a flow of coolant around the plurality of fins.

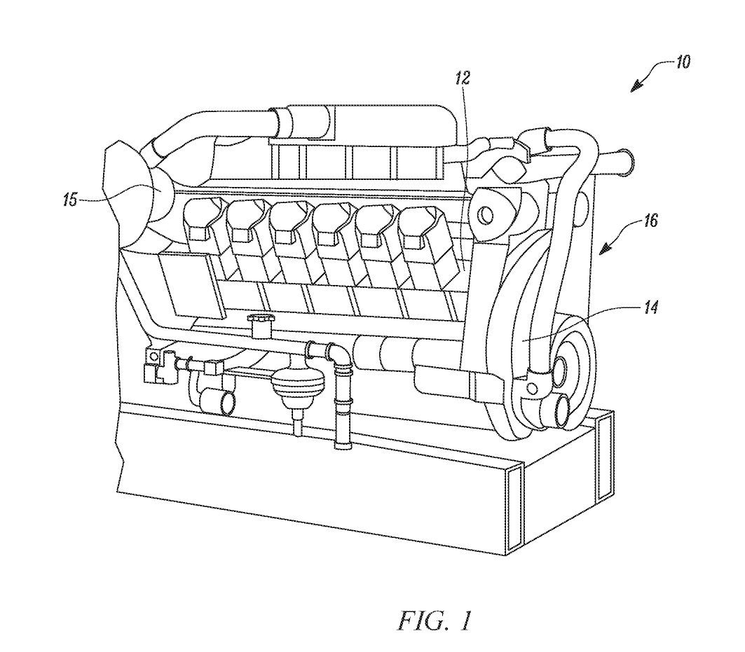

### DETAILED DESCRIPTION

Wherever possible, the same reference numbers will be used throughout the drawings to refer to the same or the like parts. FIG. 1 illustrates a perspective view of an exemplary engine 10, according to one embodiment of the present disclosure. The engine 10 is an Internal Combustion (IC) engine, such as, a gas engine, a dual fuel engine, a homogenous charge compression ignition engine or any other type of spark ignited engine or compression engine. The engine 10 may be powered by gaseous fuel including, but not limited to, natural gas, petroleum gas, coal gas, mine gas, landfill gas, and sewage gas. In one example, the engine 10 is a natural gas based reciprocating spark-ignited engine.

The engine 10 can be of a single-cylinder type engine, or a multi cylinder type engine (as shown). The engine 10 is a V-type multi-cylinder engine, however, it will be appreciated that the embodiments described herein may be used in any suitable configuration of the engine 10, including, but not limited to, inline, radial, and rotary. The engine 10 may be utilized for any suitable application, such as motor vehicles, work machines, locomotives or marine engines, and in stationary applications such as electrical power generators.

The engine 10 includes an engine housing 16. The engine housing 16 includes a cylinder head 12 and a cylinder block 14 on which the cylinder head 12 is positioned. The cylinder block 14 may include a number of cylinders (not shown). Each of the number of cylinders, hereinafter referred to as the cylinder (not shown), defines a main combustion chamber 18 that receives an air-fuel mixture for combustion. A piston (not shown) is disposed within the cylinder to reciprocate therein. An intake manifold 15 may be formed or attached to the cylinder block 14 such that the intake manifold 15 extends over or is proximate to each of the number of cylinders. Although not shown, the engine 10 may also include other components such as a crankshaft, an inlet valve, an exhaust valve, an exhaust manifold, and an after-treatment system.

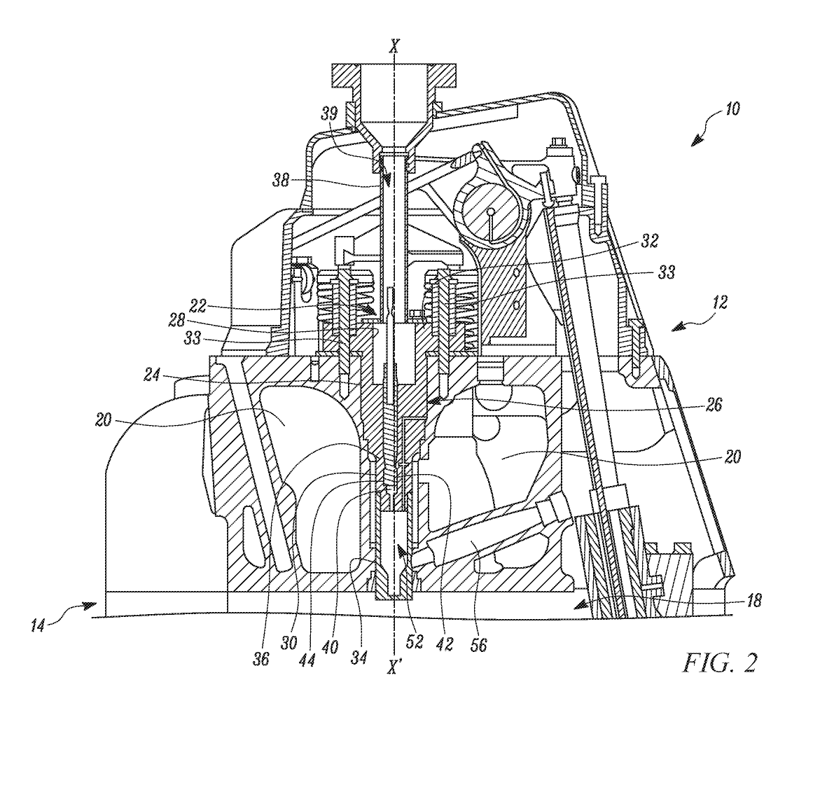

FIG. 2 illustrates a sectional view of a portion of the engine 10. The cylinder head 12 of the engine 10 defines a coolant passage 20 adapted to receive coolant for dissipating heat generated during operation of the engine 10. The coolant may include, but is not limited to, water and oil. In an example, the coolant is circulated through the coolant passage 20 by a coolant pump (not shown) associated with a cooling system (not shown) of the engine 10. The coolant pump may draw power from the engine 10 for circulating the coolant through the coolant passage 20.

The engine 10 further includes a pre-chamber assembly 22 in fluid communication with the main combustion chamber 18. The pre-chamber assembly 22 is disposed in a recess 24 defined in the cylinder head 12. The pre-chamber assembly 22 facilitates an ignition of the air-fuel mixture in the main combustion chamber 18. In an example, the pre-chamber assembly 22 disposed in the recess 24 may extend into the main combustion chamber 18.

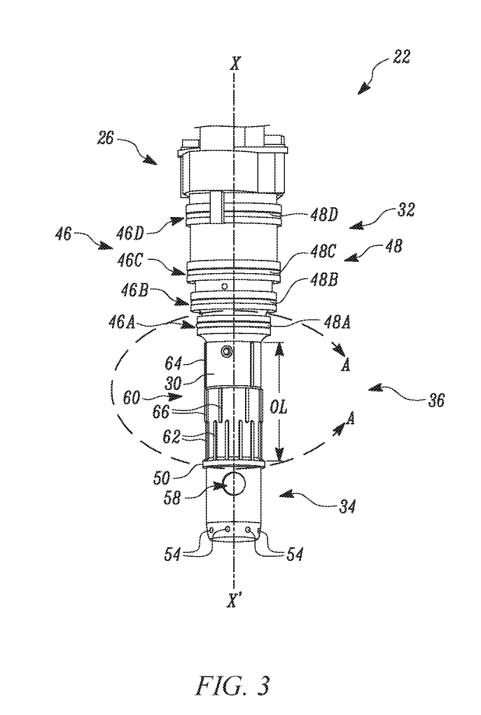

FIG. 3 illustrates a side view of the pre-chamber assembly 22. Referring to FIG. 2 and FIG. 3, the pre-chamber assembly 22 includes a body member 26 received within the recess 24 of the cylinder head 12. The body member 26 defines a longitudinal axis XX′ along a length of the body member 26. The body member 26 includes an inner surface 28 (shown in FIG. 2) and an outer surface 30 (shown in FIG. 2). In the present embodiment, the body member 26 further includes a first end portion 32, a second end portion 34 spaced apart from the first end portion 32, and an intermediate portion 36 disposed between the first end portion 32 and the second end portion 34.

The first end portion 32 is coupled to the cylinder head 12 of the engine 10 by means of fasteners 33. Further, the first end portion 32 is connected to a housing member 38. The housing member 38 (shown in FIG. 2) defines a harness passage 39 (shown in FIG. 2) adapted to receive one or more cables (not shown).

The intermediate portion 36 extends along the longitudinal axis XX′ from the first end portion 32 towards the main combustion chamber 18. The intermediate portion 36 is in contact with the coolant supplied within the coolant passage 20. The intermediate portion 36 defines a valve receiving bore 40 (shown in FIG. 2) adapted to receive a fuel admission valve 42 (shown in FIG. 2). The fuel admission valve 42 engages with a threaded section 44 (shown in FIG. 2) of the intermediate portion 36 such that the fuel admission valve 42 is retained within the valve receiving bore 40.

The fuel admission valve 42 is in fluid communication with a fuel delivery system (not shown) of the engine 10. Further, the fuel admission valve 42 is in operative communication with a controller (not shown), via the one or more cables. The fuel admission valve 42 is adapted to control the flow of the gaseous fuel received through the fuel delivery system, based on signals received from the controller.

The intermediate portion 36 also includes four annular grooves 464, 46B, 46C, 46D, collectively referred to as annular grooves 46, defined on the outer surface 30 of the intermediate portion 36. The annular grooves 46 are axially spaced apart from each other along the longitudinal axis XX′. The annular grooves 464, 46B, 46C, 46D receive four O-ring members 484, 48B, 48C, 48D, respectively, collectively referred to as O-ring members 48, for preventing leakage of the coolant from the coolant passage 20.

Further, the second end portion 34 of the body member 26 extends along the longitudinal axis XX′ from the intermediate portion 36 towards the main combustion chamber 18. The second end portion 34 is partially received within the recess 24 and is partially received within the main combustion chamber 18. A section of the second end portion 34 is in contact with the coolant supplied within the coolant passage 20. A seal member 50 is provided on the outer surface 30 of the second end portion 34 to prevent leakage of the coolant from the coolant passage 20.

The second end portion 34 also defines a pre-combustion chamber 52 (shown in FIG. 2) that receives the gaseous fuel from the fuel admission valve 42. In one example, the pre-combustion chamber 52 is frusto-conical in shape. In the present example, the second end portion 34 includes at least one orifice 54 for allowing the fluid communication between the pre-combustion chamber 52 and the main combustion chamber 18.

Further, the second end portion 34 defines a spark plug receiving bore 58 (shown in FIG. 3) for receiving a spark plug 56 that is attached to the pre-chamber assembly 22. The spark plug 56 is disposed in the spark plug receiving bore 58 such that one or more spark inducing electrodes (not shown) of the spark plug 56 are received within the pre-combustion chamber 52. The spark plug 56 ignites the air-fuel mixture present in the pre-combustion chamber 52, thereby producing ignited gases within the pre-chamber assembly 22. The ignited gases pass through the at least one orifice 54 and are introduced into the main combustion chamber 18 for igniting the air-fuel mixture present in the main combustion chamber 18.

In an example, during a normal operation condition of the engine 10, the engine 10 may be operated in a lean air-fuel ratio at which engine emissions are minimal. Due to the ignition of the lean air-fuel mixture in the pre-combustion chamber 52, a temperature of the pre-chamber assembly 22 may rise in the normal operating condition of the engine 10. Further, in a hot shutdown condition of the engine 10, the engine 10 is turned off at high loads in the normal operating condition, thereby stopping operation of the coolant pump. In such a case, the threaded section 44 of the intermediate portion 36 may be subjected to a temperature ‘T’ greater than 100 degree Celsius.

In order to facilitate cooling of the pre-chamber assembly 22 in various operating conditions including the hot shutdown condition of the engine 10, a plurality of fins 60 is disposed on the outer surface 30 of the body member 26. The plurality of fins 60 is disposed in a predetermined manner such that the plurality of fins 60 is in contact with the coolant supplied within the coolant passage 20. The plurality of fins 60 is adapted to provide an increased surface contact of the body member 26 with the coolant to enable cooling of the pre-chamber assembly 22. Thereby, the coolant maintains a temperature of the threaded section 44 below the temperature ‘T’. The coolant also cools the first end portion 32, the second end portion 34, the intermediate portion 36, and indirectly cools the fuel admission valve 42.

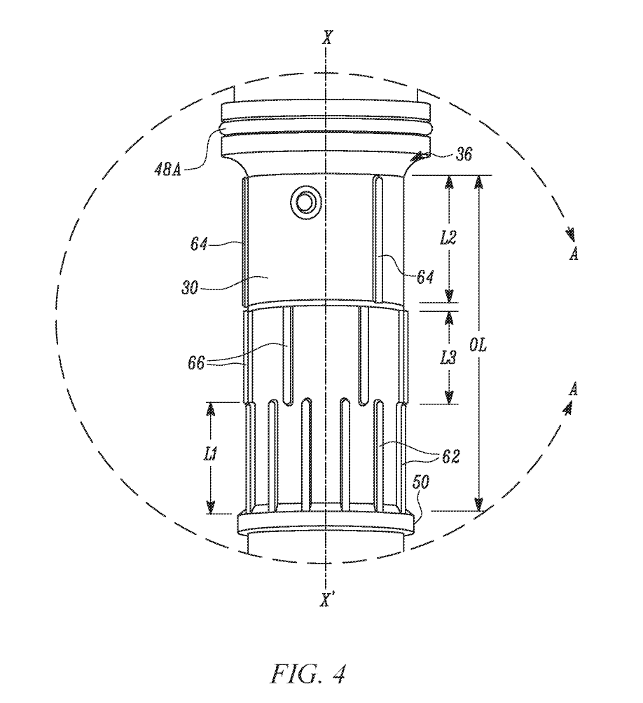

FIG. 4 illustrates an enlarged view of a region A-A′ of FIG. 3, showing the plurality of fins 60. In the present embodiment, the plurality of fins 60 is provided on a portion of the outer surface 30 defined between the O-ring member 48A and the seal member 50. Each of the plurality of fins 60 has an overall length ‘OL’. In an example, the plurality of fins 60 projects radially outward from the portion of the outer surface 30 such that the plurality of fins 60 is in contact with the coolant. In another example, the plurality of fins 60 may project radially inward from the portion of the outer surface 30 towards the inner surface 28 of the body member 26. Each fin of the plurality of fins 60 extends along the longitudinal axis XX′ of the body member 26.

The plurality of fins 60 includes a first set of fins 62, a second set of fins 64 spaced apart from the first set of fins 62, and a third set of fins 66 disposed between the first set of fins 62 and the second set of fins 64. The first set of fins 62, the second set of fins 64, and the third set of fins 66 are positioned along the longitudinal axis XX′ of the body member 26 in the predetermined pattern.

The first set of fins 62 is disposed on the outer surface 30 of the second end portion 34 of the body member 26 and is proximal to the pre-combustion chamber 52. The first set of fins 62 includes ‘N1’ number of fins 62 circumferentially spaced apart from each other about the longitudinal axis XX′. Further, each fin of the first set of fins 62 has a first length ‘L1’ considered along the longitudinal axis XX′. The ‘N1’ number of fins 62 of the first set of fins 62 may be determined based on operational and dimensional characteristics of the pre-chamber assembly 22. In one example, the ‘N1’ number of fins 62 of the first set of fins 62 may be varied in multiples of three.

The second set of fins 64 is disposed on the outer surface 30 of the first end portion 32 of the body member 26 and is proximal to the O-ring member 48A. The second set of fins 64 is spaced apart from the first set of fins 62 along the longitudinal axis XX′. The second set of fins 64 includes ‘N2’ number of fins 64 circumferentially spaced apart from each other about the longitudinal axis XX′. The ‘N2’ number of fins 64 may be varied in multiples of two and may be determined based on operational requirements. Each fin of the second set of fins 64 has a second length ‘L2’ considered along the longitudinal axis XX′. In an example, the second length ‘L2’ of the second set of fins 64 may be equal to the first length ‘L1’ of the first set of fins 62. In another example, the second length ‘L2’ of the second set of fins 64 may be less than the first length ‘L1’ of the first set of fins 62.

The third set of fins 66 is disposed between the first set of fins 62 and the second set of fins 64. The third set of fins 66 includes ‘N3’ number of fins 66 circumferentially spaced apart from each other about the longitudinal axis XX′. The ‘N3’ number of fins 66 of the third set of fins 66 is less than the ‘N1’ number of fins 62 of the first set of fins 62 and is greater than the ‘N2’ number of fins 64 of the second set of fins 64. Further, each fin 66 of the third set of fins 66 extends along the longitudinal axis XX′ of the body member 26. In one example, a ratio of the ‘N1’ number of the first set of fins 62 to the ‘N3’ number of the third set of fins 66 to the ‘N2’ number of the second set of fins 64 may be 3:2:1. Further, each fin 66 of the third set of fins 66 has a third length ‘L3’ considered along the longitudinal axis XX′. In one example, the third length ‘L3’ of the third set of fins 66 may be equal to the second length 12′ of the second set of fins 64.

It should be noted that shape of the plurality of fins 60 may vary from that shown in FIG. 3 and FIG. 4, without departing from the scope of the present disclosure. In one example, the plurality of fins 60 may have a rectangular uniform cross section along corresponding lengths ‘L1’, ‘L2’, ‘L3’. In another example, shape of the plurality of fins 60 may be similar to each other. In yet another example, shape of the plurality of fins 60 may be different from each other. Furthermore, a pattern of the first set of fins 62, the second set of fins 64, and the third set of fins 66 may vary from the pattern as shown in FIG. 3 and FIG. 4. For example, at least two of the first set of fins 62, the second set of fins 64, and the third set of fins 66 may be linearly aligned with each other.

### INDUSTRIAL APPLICABILITY

During a compression stroke of the engine 10, the gaseous fuel is injected into the pre-combustion chamber 52, via the fuel admission valve 42. Simultaneously, lean air-fuel mixture entering the pre-combustion chamber 52 mixes with the injected gaseous fuel. Subsequently, the air-fuel mixture is ignited by the spark plug 56 in the pre-combustion chamber 52. As the ignited air-fuel mixture expands, the ignited air-fuel mixture is forced out of the pre-combustion chamber 52 through the orifices 54 into the main combustion chamber 18. The ignited air-fuel mixture has high temperature. Thus, the pre-chamber assembly 22 is subjected to high temperatures during the normal operating condition and the hot shutdown condition. The plurality of fins 60 disposed on the outer surface 30 of the body member 26 provides increased heat transfer area between the body member 26 and the coolant, thereby aiding efficient cooling of the pre-chamber assembly 22 during various operating conditions of the engine 10. In an example, the plurality of fins 60 may be integrated in the pre-chamber assembly and in another example, the plurality of fins 60 may also be easily assembled in existing pre-chamber assemblies.

During the normal operating condition of the engine 10, the coolant pump circulates the coolant within the coolant passages 20 of the cylinder head 12. The plurality of fins 60 of the pre-chamber assembly 22 provide increased surface contact with the circulating coolant, thereby effectively cooling the pre-chamber assembly 22. Moreover, since the ratio of the ‘N1’ number of fins 62 of the first set of fins 62 to the ‘N3’ number of fins 66 of the third set of fins 66 to the ‘N2’ number of fins 64 of the second set of fins 64 is 3:2:1, restriction offered to the flow of the coolant decreases from the first set of fins 62 towards the second set of fins 64. Hence, the coolant flow at the vicinity of the second end portion 34 is stimulated to flow towards the first end portion 32 of the engine 10 as coolant passage volume increases from the first set of fins 62 to the second set of fins 64. Therefore, a power consumption by the coolant pump is substantially reduced.

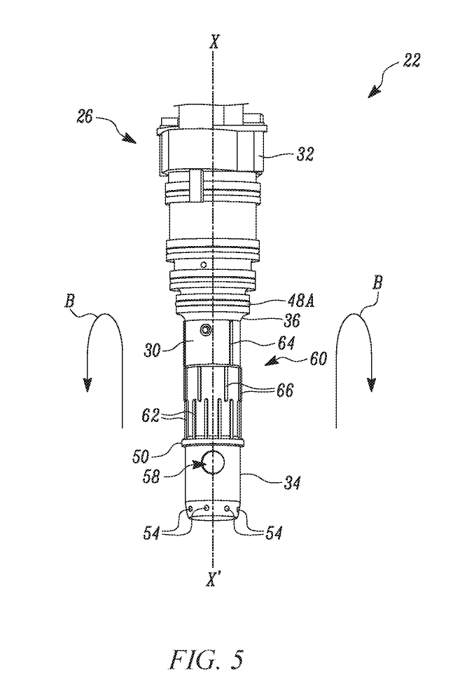

During the hot shutdown condition, the coolant is allowed to flow around the first set of fins 62, the second set of fins 64, and the third set of fins 66. Referring to FIG. 5, the flow of the coolant around the plurality of fins 60 during the hot shutdown condition is illustrated. Due to increasing number of the plurality of fins 60 from the second set of fins 64 to the first set of fins 62, a coolant passage volume through the first set of fins 62 is lower than a coolant passage volume through the second set of fins 64. Based on the increasing coolant passage volume and a temperature gradient between the first set of fins 62 and the second set of fins 64, a flow of coolant (indicated by arrows ‘B’) is obtained around the plurality of fins 60. This causes natural convective heat transfer between the body member 26 and the coolant. During natural convective heat transfer, the coolant surrounding the first set of fins 62 absorbs heat and becomes less dense which causes an upward flow of the coolant to the second set of fins 64. The pre-chamber assembly 22 is effectively cooled during the hot shutdown condition by natural convective heat transfer, thereby overheating of the fuel admission valve 42 and the boiling of the coolant is eliminated. Further, based on the number of the plurality of fins 60 in the first, second, and third sets of fins 62, 64, 66, respectively, an effective heat transfer area between the body member 26 and the coolant substantially reduces from the first set of fins 62 to the second set of fins 64. This facilitates in obtaining a uniform distribution of temperature within the body member 26, thereby substantially reducing the thermal stress in the body member 26.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A pre-chamber assembly for an engine having a cylinder head defining a coolant passage therein, the pre-chamber assembly comprising:
a body member received within the cylinder head, the body member having an inner surface and an outer surface facing the coolant passage of the cylinder head, the body member defining a pre-combustion chamber at an end portion thereof, wherein the pre-combustion chamber is in communication with a main combustion chamber of the engine through at least one orifice; and
a plurality of fins projecting radially from the outer surface of the body member, the plurality of fins being in contact with coolant received within the coolant passage of the cylinder head, each fin of the plurality of fins extends along a longitudinal axis of the body member, wherein the plurality of fins are positioned along the longitudinal axis of the body member in a predetermined pattern, the plurality of fins including:
a first set of fins provided on the outer surface of the body member and proximate to the pre-combustion chamber defined at the end portion of the body member;
a second set of fins provided on the outer surface of the body member and spaced apart from the first set of fins along the longitudinal axis; and
a third set of fins provided on the outer surface of the body member and disposed between the first set of fins and the second set of fins,
wherein a number of fins of the first set of fins is greater than a number of fins of the third set of fins, and the number of fins of the third set of fins is greater than a number of fins of the second set of fins.
